(19) United States
(12) Patent Application Publication
(10) Pub. No.: US 2006/0214804 A1
(43) Pub. Date: Sep. 28, 2006

(54) Package

(75) Inventor: Sadayoshi Mochida, Numazu-shi (JP)

Correspondence Address: PEARNE & GORDON LLP, 1801 EAST 9TH STREET, SUITE 1200, CLEVELAND, OH, 44114-3108, US

(73) Assignee: TOSHIBA TEC KABUSHIKI KAISHA, Tokyo (JP)

(21) Appl. No.: 11/362,891

(22) Filed: Feb. 27, 2006

(30) Foreign Application Priority Data
Mar. 28, 2005 (JP) JP2005-091414

(51) Int. Cl. G08B 13/14

(52) U.S. Cl. 340/572.8; 340/572.1

(57) ABSTRACT

A package for articles with radio-frequency-identification (RFID) tags, wherein the side faces of the package have an elastic bending structure.

### CROSS-REFERENCE TO RELATED APPLICATION

This application is based upon and claims the benefit of priority from prior Japanese Patent Application No. 2005-91414, filed on Mar. 28, 2005, the entire contents of which are incorporated herein by reference.

### BACKGROUND OF THE INVENTION

1. Field of the Invention

The present invention relates to packages for packing articles with information readable/writable radio-frequency-identification (RFID) tags.

2. Description of the Related Art

Moves are recently afoot to control various articles using RFID tags. For relatively small or thin articles to be controlled with RFID tags, they are frequently controlled in a relatively large package of several pieces.

In this case, however, the articles are packed close to one another and as such, RFID tags also come close to one another. This makes it difficult to read and write tag information of articles with RFID tags because of the mutual interference among the RFID tags. To reduce the mutual interference of the RFID tags, a method of preventing the mutual interference is disclosed which uses shielding sheets while separating the RFID tags from one another by a distance at which no mutual interference occurs, that is, keeping the distance among the articles from one another (for example, refer to JP-A-2004-246816).

However, in this case, since a specified distance must be kept among the articles, the package of the articles becomes bulky, thus posing the problem of increasing the space for storing the package.

### BRIEF SUMMARY OF THE INVENTION

The invention has been made in consideration of the problems of an increase of the size of a package with an RFID tag, resulting in increasing the space for storing the package. Accordingly, an advantage of the present invention is to provide a package which can be decreased in volume when packing articles and in which information of the RFID tags stuck to the articles can easily be read and written.

To achieve the above advantage, one aspect of the present invention is to provide a package for articles with radio-frequency-identification (RFID) tags, wherein the side faces of the package have an elastic bending structure.

According to an aspect of the invention, a package can be decreased in volume when packing articles, wherein information of the RFID tags stuck to the articles can easily be read and written individually without mutual interference among the RFID tags.

### BRIEF DESCRIPTION OF THE DRAWINGS

FIG. 1 is a perspective view of the overall structure of a package according to an embodiment of the invention;

FIG. 2A is a perspective view of the package in a normal state according to an embodiment of the invention;

FIG. 2B is a sectional view thereof;

FIG. 3A is a perspective view of the package in a stored state according to an embodiment of the invention; and

FIG. 3B is a sectional view thereof.

### DETAILED DESCRIPTION OF THE INVENTION

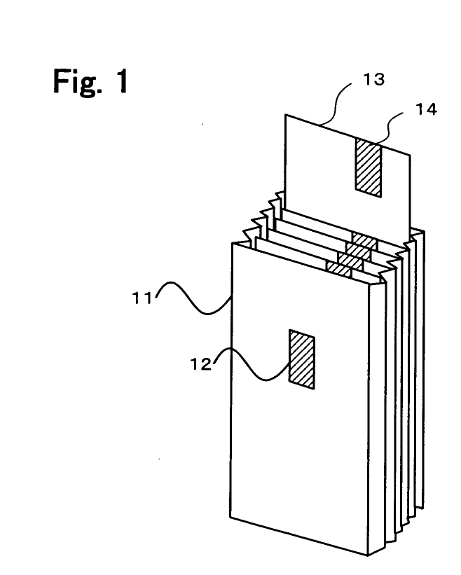

An embodiment of the invention will be described hereinbelow with reference to the drawings. FIG. 1 shows the overall structure of a package for documents according to an embodiment of the invention, which includes a package 11, a radio-frequency-identification (RFID) tag 12 stuck to the package, a document 13 to be packed, and an RFID tag 14 stuck to the document 13.

The package 11 is open to the top, and has planer front and back faces. The front and back faces have a pair of side faces connected together. The lower ends of the front and back faces also connect to construct the bottom. The pair of side faces has an elastic bending structure, and is made of a foaming material or the like. The package 11 is shaped like a bag as a whole, and has a strength to resist for the documents 13 fully packed.

The document 13 to be packed includes one or more pieces of paper, envelopes that contain paper, and books, and has the RFID tag 14 on the upper front thereof, for example. The RFID tag 14 stores unique identification information (ID code) and other various information including the title and the keyword of the document or the like.

The package 11 itself has the RFID tag 12 on the front face. The RFID tag 12 can store the category or class of the document 13 packed in the package 11.

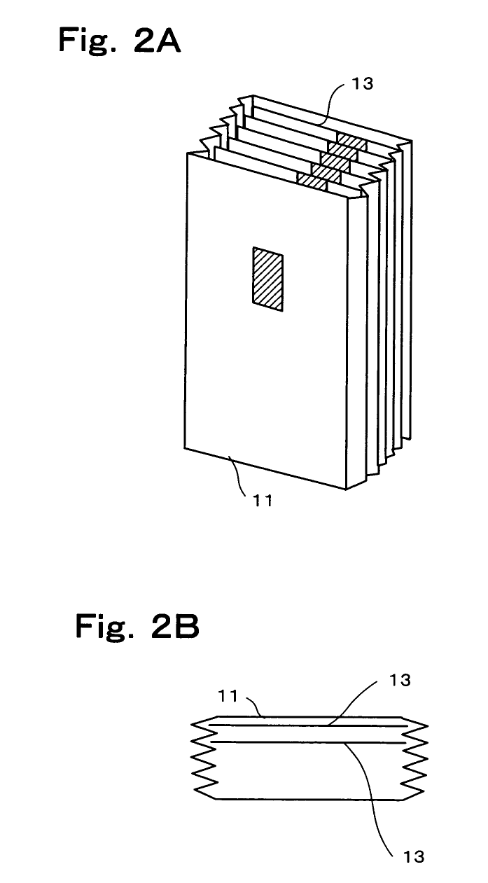

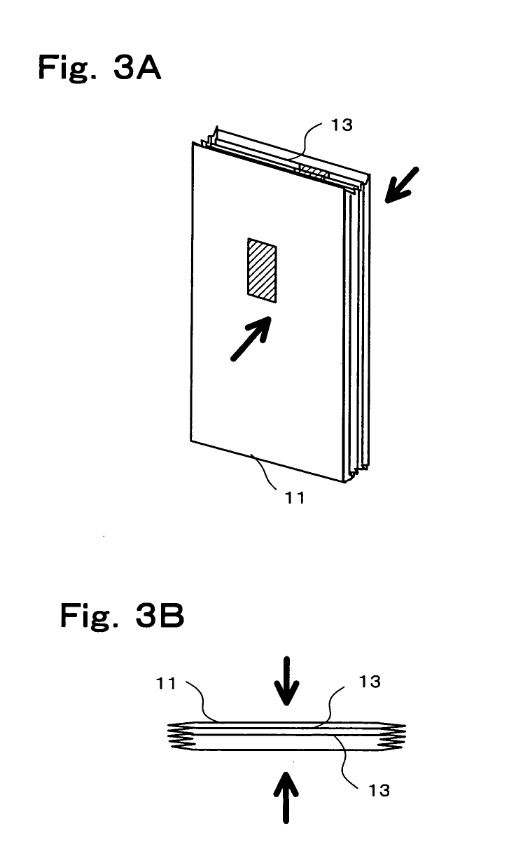

FIGS. 2A and 2B show the normal state of the package 11 according to the embodiment of the invention. FIGS. 3A and 3B show a state in which the package 11 that contains the documents 13 is stored in a shelf or the like. FIG. 2A is a perspective view of the normal state of the package 11 that contains the documents 13, and FIG. 2B is a sectional view thereof. FIG. 3A is a perspective view of the package 11 that contains the documents 13 in a stored state, and FIG. 3B is a sectional view thereof.

The package 11 shown in FIGS. 2A and 2B is deformed by an external force applied to the front and back faces because of the elastic bending structure of the right and left sides and the bottom, so that the front and back faces come cross to each other to form the shape shown in the perspective view of FIG. 3A and the sectional view of FIG. 3B.

As shown in the sectional view of FIG. 2B, the two documents 13 in the package 11 in normal times are guided by the folds of the right and left sides of the bending structure. That is, the side ends of each document 13 in the package 11 are held by the bending structure of the pair of side faces.

Accordingly, the documents 13 are separated by a distance at which no mutual interference of the RFID tags 14 on the documents 13 occurs, so that the RFID tags 14 of the documents 13 can be read without mutual interference.

As shown in the sectional view of FIG. 3B, the package 11 is compressed by an external force applied to the front and back faces when stored. In other words, deforming the package 11 in such a manner that the front and back faces come close minimizes the storage space for the package 11.

Since the package according to the embodiment is made of a foaming material, it has the advantage of providing a package strong enough to pack a massive document. However, when at least the side faces are made of a foaming material, the package is given elasticity. When not only the side faces but also the bottom are made of a foaming material, the package is more likely to be compressed by an external force. In the package according to the invention, at least one or both of the side faces has only to have elasticity, and may not necessarily be made of a foaming material.

The package according to the embodiment has the advantage of facilitating reading of RFID tags stuck to documents by keeping the distance among the RFID tags to reduce the mutual interference of the RFID tags in normal times, and minimizing the storage volume only by applying an external force when stored. The embodiment also has the function of floating the documents in the package, or separating the documents from one another, owing to the bending structure of the side faces, thus offering the advantage of facilitating reading the documents even if the documents themselves have no elasticity.

However, documents generally have elasticity to some extents. Accordingly, the bending structure of the side faces has not necessarily to have the function of floating the documents. This is because documents are generally released to separate the RFID tags when an external force is eliminated, thus facilitating reading the RFID tags.

While the embodiment has been described for the case in which documents are packed in a package, it is to be understood that the invention is applied not only to the package for documents but also packages for various other articles within the sprit and scope of the invention.

What is claimed is:

1. A package for articles with radio-frequency-identification (RFID) tags, wherein
the side faces of the package have an elastic bending structure.

2. The package according to claim 1, wherein at least the side faces having the bending structure is made of a foaming material.

3. A package for documents with an RFID tag, wherein
the side faces of the package have an elastic bending structure in which the documents are held when an external force from the front or back faces of the package is released.

4. The package according to claim 3, wherein the package is formed of a foaming material.

5. A bag-shaped package comprising:
a front face larger than a document with a RFID tag;
a back face larger than the document;
a pair of side faces connecting the both sides of the back face and the front face and having an elastic bending structure; and
a bottom face connecting the back face and the front face at the lower ends thereof.

6. The package according to claim 5, wherein the front face has an RFID tag to which information on the document to be packed in the package is written.

7. The package according to claim 6, wherein the pair of side faces is formed of a foaming material.

8. The package according to claim 7, wherein the bottom face is formed of a foaming material.

9. The package according to claim 8, wherein the pair of side faces can hold the document packed in the package at the side ends thereof with the bending structure.
